(19) United States
(12) Patent Application Publication
(10) Pub. No.: US 2014/0313656 A1
(43) Pub. Date: Oct. 23, 2014

(54) KEYBOARD

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventors: TAI-AN TSAO, New Taipei (TW); TING-YU WANG, New Taipei (TW); CHIH-HUNG TSAI, New Taipei (TW); HSIEH-CHIH CHIANG, New Taipei (TW); BO-DUO YUAN, Shenzhen (CN)

(73) Assignees: HON HAI PRECISION INDUSTRY CO., LTD., New Taipei (TW); HONG FU JIN PRECISION INDUSTRY (ShenZhen) CO. LTD., Shenzhen (CN)

(21) Appl. No.: 14/038,803

(22) Filed: Sep. 27, 2013

(30) Foreign Application Priority Data
Apr. 19, 2013 (CN) 201310137389X

(51) Int. Cl. G06F 3/02

(52) U.S. Cl. CPC G06F 3/02
USPC 361/679.08; 400/472

(57) ABSTRACT

A keyboard applied to an electronic device, includes a main body, a connecting panel, and at least one fixing member. The connecting panel and the main body are fastened together by the at least one fixing member. An electronic device using the keyboard is also provided.

### BACKGROUND

1. Technical Field

The present disclosure relates to keyboards, and more particularly, to a keyboard applied to an electronic device.

2. Description of Related Art

Keyboards are widely employed by electronic devices, such as, notebook computers. The keyboards are typically assembled by bolts or soldering, and a large space should be provided for allowing the processes of bolts or soldering, which may hinder the miniaturization of the electronic device.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of a keyboard assembled to an electronic device in accordance with an embodiment.

FIG. 2 is a disassembled view of the keyboard in FIG. 1.

FIG. 3 is similar to FIG. 2, but viewed from another aspect.

FIG. 4 is an enlarged view of part IV in FIG. 3.

FIG. 5 is similar to FIG. 4, but viewed from another aspect.

FIG. 6 is an enlarged view of part VI in FIG. 2.

FIG. 7 is similar to FIG. 6, but viewed from another aspect.

FIG. 8 is an assembled view of the keyboard in FIG. 2.

FIGS. 9 and 10 are cross-sectional views taken along line IX-IX of FIG. 8, showing the assembling process of the keyboard of FIG. 8.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

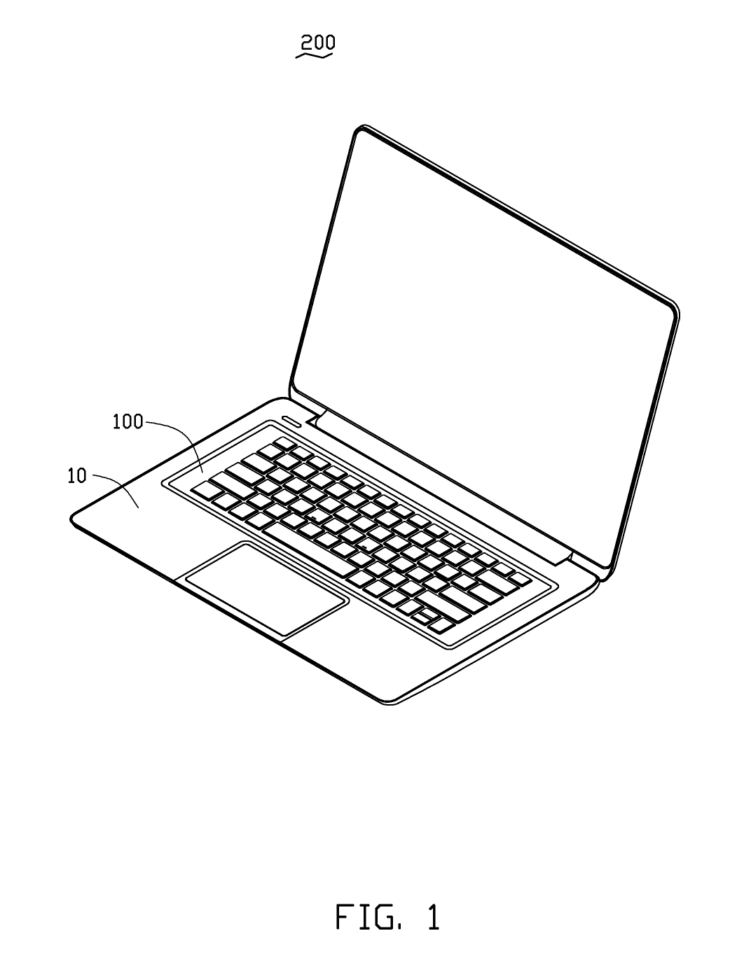

FIG. 1, illustrates a keyboard 100 mounted to a housing 10 of an electronic device 200. The keyboard 100 receives operation to allow users to control the electronic device 200. The electronic device 200 can be a mobile phone, a notebook computer, or a personal digital assistant (PDA), for example. In the embodiment, the electronic device 200 is a notebook computer.

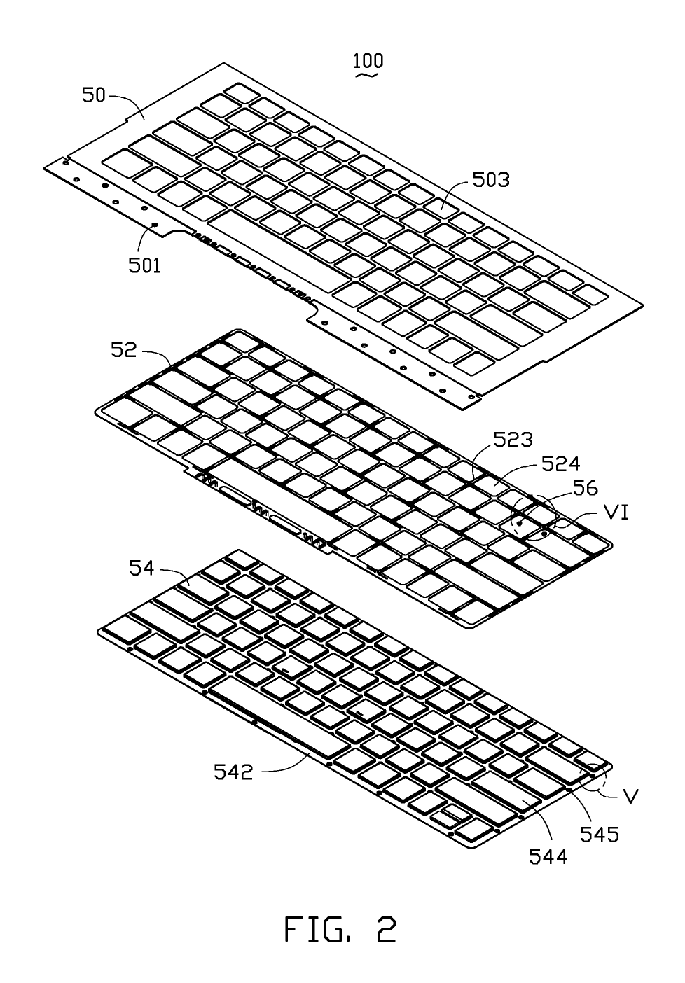

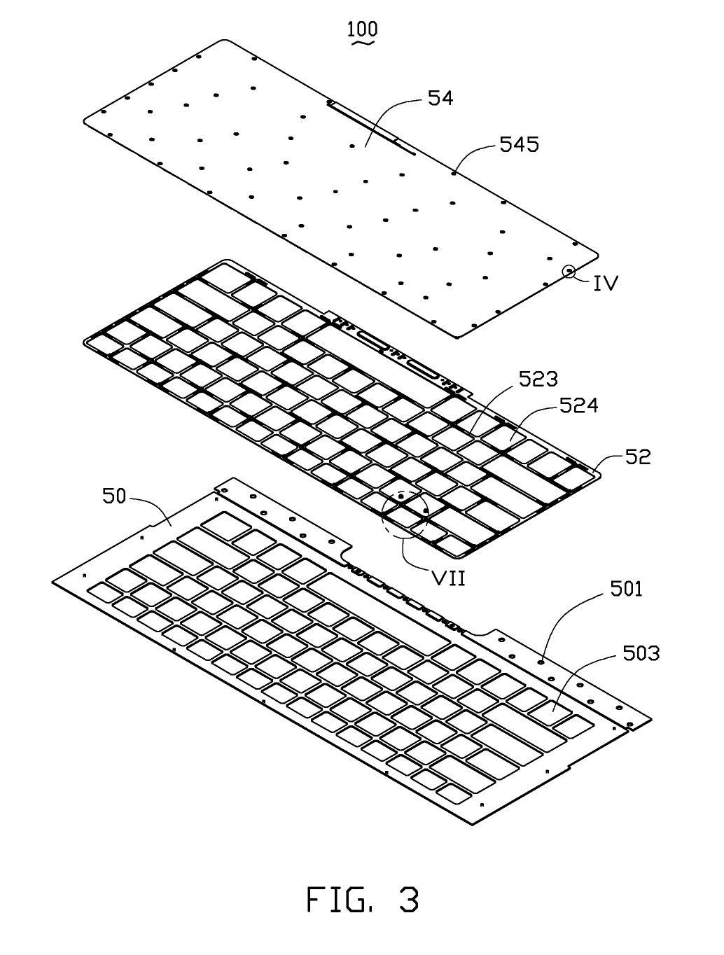

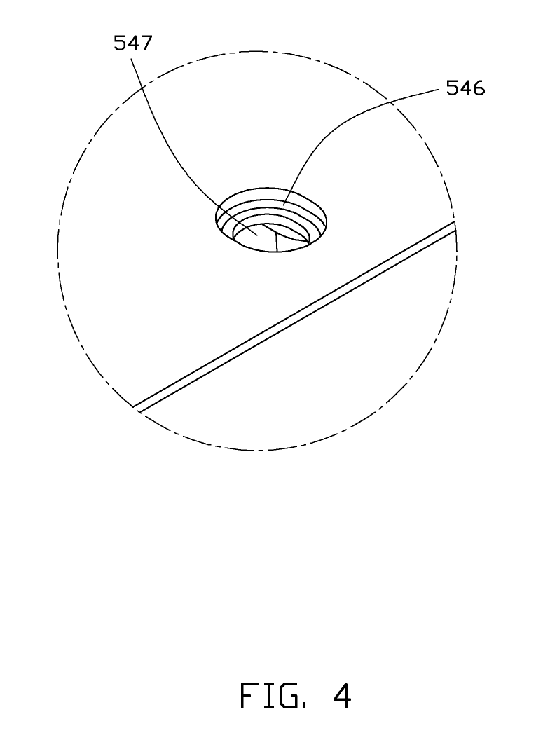

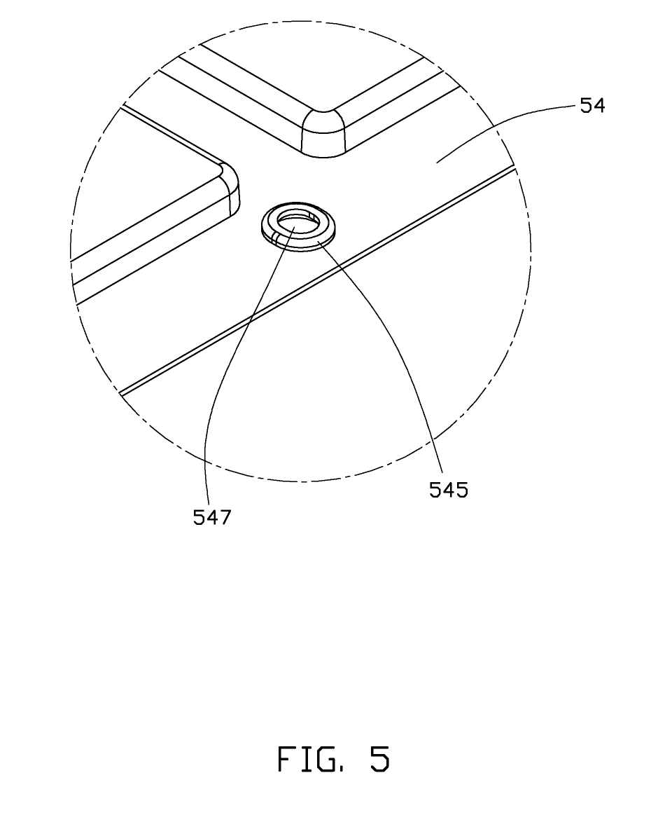

FIGS. 2 and 3 show that the keyboard 100 includes a main body 54, a connecting panel 52, a fixing panel 50, and a number of fixing members 56. The main body 54 is substantially rectangular. The main body 54 includes a base 542 and a number of keys 544 mounted on a top surface of the base 542. FIGS. 4 and 5 show that a number of protrusions 545 are arranged adjacent to rims of the top surface of the base 542. When viewed from the top surface of the base 542, each protrusion 545 protrudes from the top surface of the base 542. When viewed from a bottom surface of the base 542, the protrusion 545 is recessed from the bottom surface to define a punch hole 546. The bottom of the punch hole 546 further defines a through hole 547.

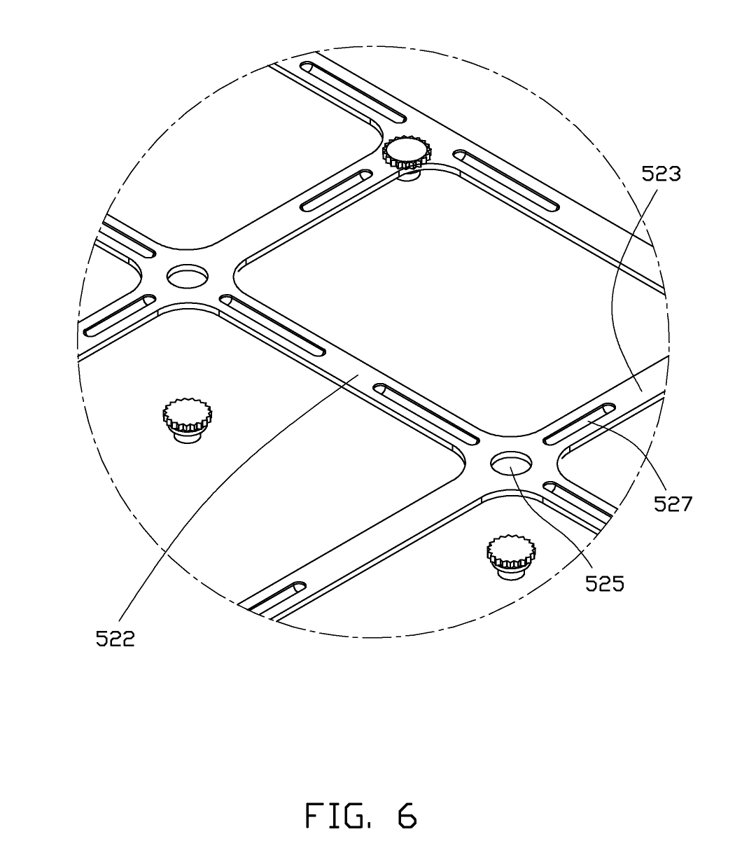

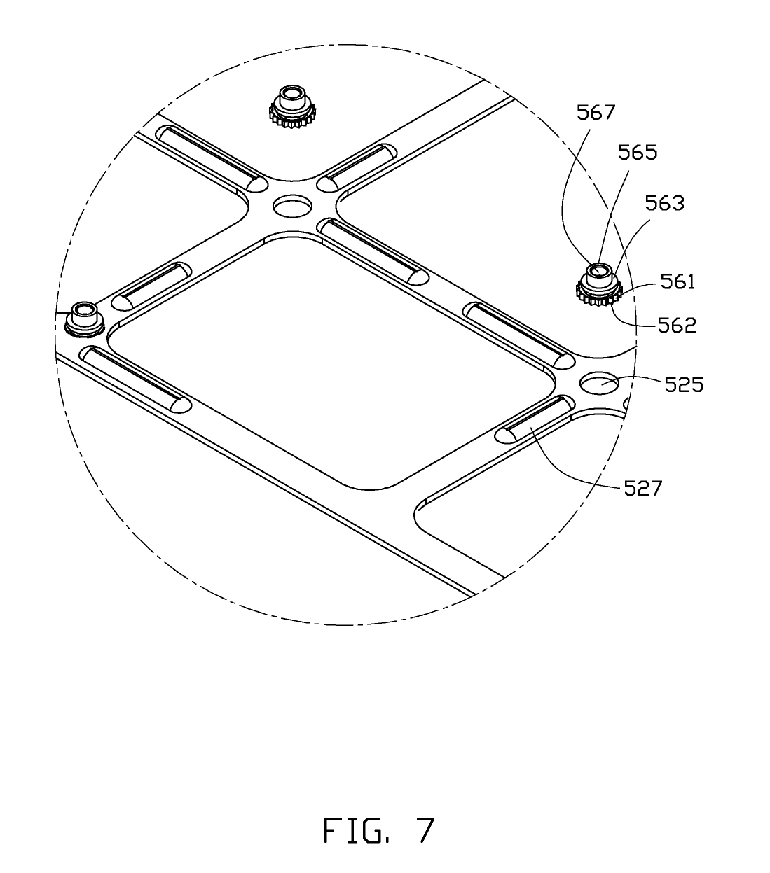

FIGS. 6 and 7 show that the connecting panel 52 is a substantially rectangular sheet, and fits the main body 54. The connecting panel 52 is made of metal, such as aluminum, aluminum alloy. The connecting panel 52 defines a number of first openings 524. The first openings 524 correspond to and receive the keys 544. The first openings 524 are divided into six columns. A first rib 522 is arranged between two adjacent columns of first openings 524. A second rib 523 is arranged between two adjacent first openings 524 in the same column. The second ribs 523 intersect with adjacent first ribs 522. The joints of the first and second ribs 522, 523 define a number of mounting holes 525. The mounting holes 525 correspond to the protrusions 545 arranged on the top surface of the base 542. The first rib 522 and the second ribs 523 define a number of recesses 527 surrounding each mounting hole 525. In the embodiment, a part of one first rib 522 between two adjacent mounting holes 525 defines two recesses 527 respectively adjacent to the mounting holes 525, and one of the second ribs 523 connected to the joint defines a recess 527.

FIG. 7 shows that the fixing members 56 are adapted to fasten the connecting panel 52 and the main body 50 together. In the embodiments, the fixing members 56 are tubular rivets. Each fixing member 56 includes a head portion 561, a connecting potion 563, and a tail 565. The head portion 561 is substantially disk shaped. A number of teeth 562 protrude radially outward from the head portion 561. The head portion 561 is fitted into the mounting hole 525, to impede free rotation of the fixing member 56. The connecting portion 563 is substantially cylindrical, and protrudes from the center of the head portion 561. The diameter of the connecting portion 563 is greater than the diameter of the through hole 547. The tail 565 is substantially a hollow cylinder, and protrudes from an end of the connecting portion 563 away from the head portion 561. The tail 565 defines a hollow space 567. The diameter of the tail 565 is slightly less than the diameter of the through hole 547.

The fixing panel 50 is substantially a rectangular sheet. The fixing panel 50 further defines a number of fixing holes 501. The fixing holes 501 are arranged adjacent to rims of the fixing panel 50. The fixing panel 50 is fixed to the housing of the electronic device 200 by bolts (not shown) extending through the fixing holes 501. The fixing panel 50 further defines a number of second opening 503 corresponding to the first openings 524.

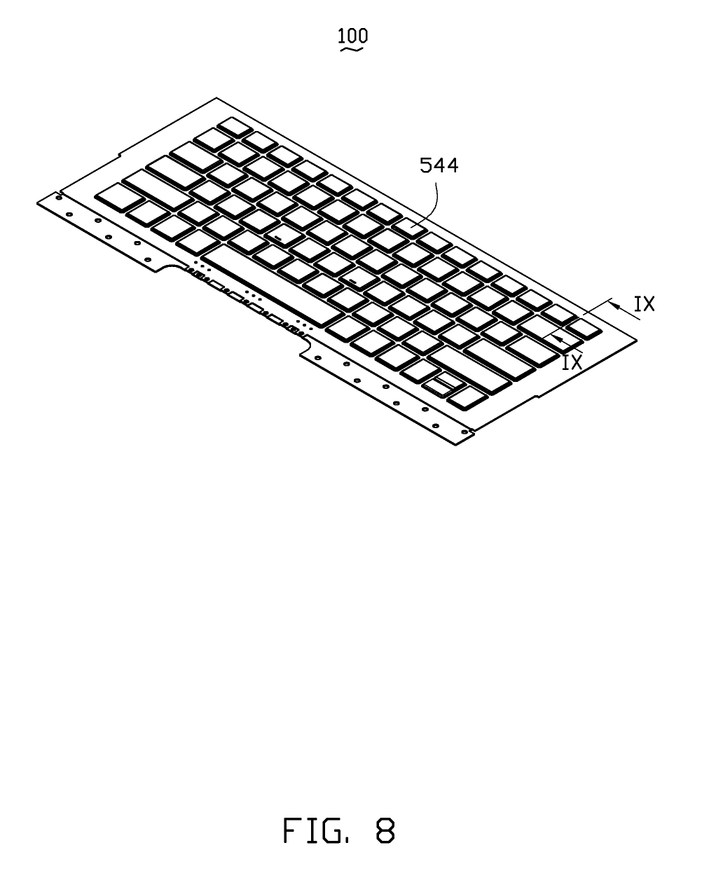

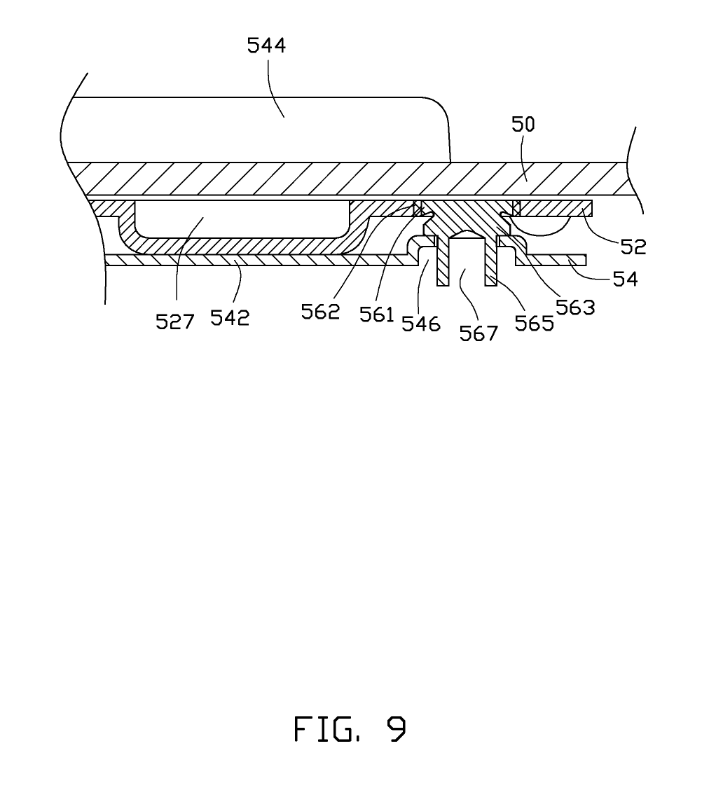

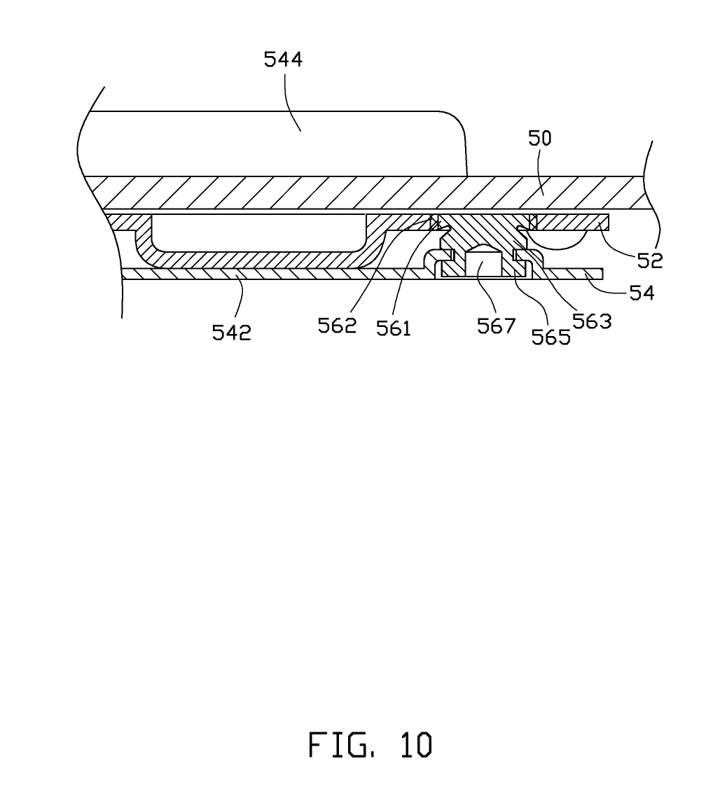

FIGS. 8-10 show that in assembly, first, the head portions 561 are fitted into the corresponding mounting holes 525. Second, the keys 544 are extended through the first openings 524, and the tails 565 are extended through the corresponding through holes 547. Then, the tails 565 are punched to form a buck-tail 566 housed in the punch hole 546, wherein the buck-tail 566 expands to about 1.5 times the original diameter of the tail 565, thereby holding the fixing members 56 in place. As a result, the connecting panel 52 is easily fixed to the main body 50. Then, glue is coated on the head portions 561 and the fixing panel 50 covers the connecting panel 52 opposite to the main body 54 and is further depressed, whereby the fixing panel 50 is fixed to the connecting panel 52 by the glue. At the same time, excess glue will flow into the recesses 527, to avoid leakage. Finally, the fixing panel 50 is fixed to the housing of the electronic device 100, with the connecting panel 52 electrically grounded by the housing of the electronic device 100.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A keyboard applied to an electronic device having a housing, comprising:
a main body comprising a plurality of keys, the main body defining at least one punch hole;
a connecting panel defining at least one mounting hole corresponding to the at least one punch hole; and
at least one fixing member comprising a head portion and a tail;
wherein the head portion is fitted into the mounting hole to fix the at least one fixing member to the connecting panel, and the tail extends through the punch hole and is further riveted to a bottom surface of the main body opposite to the connecting panel, to fasten the connecting panel and the main body together.

2. The keyboard of claim 1, wherein the connecting panel defines a plurality of first openings, the first openings correspond to and receive the keys.

3. The keyboard of claim 2, wherein the first openings are arranged in at least two columns, a first rib is arranged between two adjacent columns of first openings, and a second rib is arranged between two adjacent first openings in the same column.

4. The keyboard of claim 3, wherein the second ribs intersect with the first ribs, and the at least one mounting hole is defined at one of joints of the first and second ribs.

5. The keyboard of claim 4, further comprising a fixing panel for fixing the keyboard to the housing of the electronic device, wherein the fixing panel is fastened to the connecting panel by coating glue on the head portion being fitted into the mounting hole.

6. The keyboard of claim 5, wherein the first rib and the second ribs surrounding the mounting holes define at least one recess, the at least one recess receives excess glue after the connecting panel is fastened to the main body by glue coated on the head portion

7. The keyboard of claim 1, wherein the connecting panel is made from metal, and is grounded by the housing of the electronic device after the keyboard is mounted to the housing of the electronic device.

8. An electronic device comprising:
a housing; and
a keyboard mounted to the housing, the keyboard comprising:
a main body comprising a plurality of keys, the main body defining at least one punch hole;
a connecting panel defining at least one mounting hole corresponding to the at least one punch hole; and
at least one fixing member comprising a head portion and a tail;
wherein the head portion is fitted into the mounting hole to fix the at least one fixing member to the connecting panel, and the tail extends through the punch hole and is further riveted to a bottom surface of the main body opposite to the connecting panel, to fasten the connecting panel and the main body together.

9. The electronic device of claim 8, wherein the connecting panel defines a plurality of first openings, the first openings correspond to and receive the keys.

10. The electronic device of claim 9, wherein the first openings are arranged in at least two columns, a first rib is arranged between to two adjacent columns of first openings, and a second rib is arranged between two adjacent first openings in the same column.

11. The electronic device of claim 10, wherein the second ribs intersect with the first rib, and the at least one mounting hole is defined at one of joints of the first and second ribs.

12. The keyboard of claim 11, wherein the keyboard further comprises a fixing panel for fixing the keyboard to the housing of the electronic device, the fixing panel is fastened to the connecting panel by coating glue on the head portion being fitted into the mounting hole.

13. The electronic device of claim 12, wherein the first rib and the second ribs surrounding the mounting holes define at least one recess, the at least one recess receives excess glue after the connecting panel is fastened to the main body by glue coated on the head portion

14. The electronic device of claim 8, wherein the connecting panel is made from metal, and is grounded by the housing of the electronic device after the keyboard is mounted to the housing of the electronic device.
